(19) United States
(12) Patent Application Publication
(10) Pub. No.: US 2015/0055374 A1
(43) Pub. Date: Feb. 26, 2015

(54) SWITCHING POWER SUPPLY APPARATUS CORRESPONDING TO ZERO VOLTAGE SWITCHING SYSTEM

(71) Applicant: FUJITSU TELECOM NETWORKS LIMITED, Kawasaki-shi (JP)

(72) Inventors: Shigeharu Yamashita, Kawasaki-shi (JP); Tooru Yoshino, Kawasaki-shi (JP)

(73) Assignee: FUJITSU TELECOM NETWORKS LIMITED, Kawasaki-shi (JP)

(21) Appl. No.: 14/096,993

(22) Filed: Dec. 4, 2013

(30) Foreign Application Priority Data
Aug. 22, 2013 (JP) 2013-172383
Sep. 13, 2013 (JP) 2013-190954

(51) Int. Cl. H02M 3/335

(52) U.S. Cl. CPC H02M 3/33507
USPC 363/17

(57) ABSTRACT

In a full bridge type DC-DC converter, a first protective diode is connected between a first node between a first resonance inductor on a primary side and one terminal of a primary winding of a transformer, and a power line on a high voltage side of a power supply. A second protective diode is connected between the first node and a power line on a low voltage side of the power supply. A third protective diode is connected between a second node between a second resonance inductor and the other terminal of the primary winding, and the power line on the high voltage side of the power supply. A fourth protective diode is connected between the second node and the power line on the low voltage side of the power supply.

### BACKGROUND OF THE INVENTION

1. Field of the Invention

The present invention relates to a switching power supply apparatus of zero voltage switching (ZVS) system.

2. Description of the Related Art

In switching power supplies, soft switching with switching losses of switching elements reduced is put to practical use. As examples of the switching power supply in which the soft switching is implemented, there are a full bridge circuit of phase shift system and a forward type converter of active clamp system. In this circuit, resonance caused by parasitic capacitances formed respectively in parallel with switching elements and inductance connected in series with a primary winding of a transformer is used. Zero voltage switching is implemented by turning ON a switching element when a voltage across the switching element has become zero owing to this resonance (see, for example, JP 2003-158873 A).

The switching loss is caused because a switching element is turned ON in a state in which a parasitic capacitance of the switching element has charge stored therein and the parasitic capacitance is short-circuited. If series resonance of the parasitic capacitance and the inductance is used, therefore, it is possible to let a current flow through the parasitic capacitance in a reverse direction by using energy stored in the inductance and make the parasitic capacitance zero.

Patent Literature 1: JP 2003-158873 A

For implementing the above-described zero voltage switching, it is necessary to provide an inductance between the switching element and the primary winding of the transformer. In this configuration, resonance also occurs between the inductance and a parasitic capacitance of a diode included in a rectifier circuit on a secondary side of the transformer. Because of this resonance, voltage vibration and a surge voltage are generated at a node between the inductance and the parasitic capacitance. This voltage vibration results in a power loss of the whole circuit, and the surge voltage becomes a cause of a trouble in parts.

### SUMMARY OF THE INVENTION

In the view of such a situation, the present invention has been made. A purpose of the present invention is to provide a technique that reduces influence of resonance generated by inductance on the primary side and a capacitance component on the secondary side in switching power supply apparatuses.

In order to solve the above problem, a full bridge type switching power supply apparatus according to an aspect of the present invention includes: a full bridge circuit having a parallel connection of a first arm including two switching elements and a second arm including two switching elements; a transformer which transforms output power of the full bridge circuit; a first inductor connected between an output terminal of the first arm and one terminal of a primary winding of the transformer; a second inductor connected between an output terminal of the second arm and the other terminal of the primary winding of the transformer; a rectifier circuit connected to a secondary winding of the transformer to rectify output power of the transformer; a smoothing circuit which smoothes power rectified by the rectifier circuit; a first diode of which an anode terminal is connected to a first node between the first inductor and the one terminal of the primary winding, and of which a cathode terminal is connected to a power line on a high voltage side of a power supply which supplies power to the full bridge circuit; a second diode of which a cathode terminal is connected to the first node and of which an anode terminal is connected to a power line on a low voltage side of the power supply; a third diode of which an anode terminal is connected to a second node between the second inductor and the other terminal of the primary winding, and of which a cathode terminal is connected to the power line on the high voltage side of the power supply; and a fourth diode of which a cathode terminal is connected to the second node and of which an anode terminal is connected to the power line on the low voltage side of the power supply.

Another aspect of the present invention is also a full bridge type switching power supply apparatus. The apparatus includes: a full bridge circuit having a parallel connection of a first arm including two switching elements and a second arm including two switching elements; a transformer which transforms output power of the full bridge circuit; a first inductor connected between an output terminal of the first arm and one terminal of a primary winding of the transformer; a rectifier circuit connected to a secondary winding of the transformer to rectify output power of the transformer; a smoothing circuit which smoothes power rectified by the rectifier circuit; a first diode of which an anode terminal is connected to a first node between the first inductor and the one terminal of the primary winding, and of which a cathode terminal is connected to a power line on a high voltage side of a power supply which supplies power to the full bridge circuit; and a second diode of which a cathode terminal is connected to the first node and of which an anode terminal is connected to a power line on a low voltage side of the power supply.

Another aspect of the present invention is a two-transistor forward type switching power supply apparatus. The apparatus includes: a two-transistor forward type switching circuit of active lamp system; a transformer which transforms output power of the two-transistor forward type switching circuit; an inductor connected between the two-transistor forward type switching circuit and a primary winding of the transformer; a rectifier circuit connected to a secondary winding of the transformer to rectify output power of the transformer; a smoothing circuit which smoothes power rectified by the rectifier circuit; and a diode of which an anode terminal is connected to a first node between the inductor and the primary winding of the transformer, and of which a cathode terminal is connected to a power line of a power supply which supplies power to the two-transistor forward type switching circuit.

By the way, an arbitrary combination of components described heretofore, and results obtained by converting expression of the present invention among an apparatus, a method, a system, and the like are also effective as aspects of the present invention.

### BRIEF DESCRIPTION OF THE DRAWINGS

FIG. 1 is a diagram illustrating a basic configuration example of a full bridge type DC-DC converter;

FIG. 2 is a diagram illustrating a timing chart for explaining an operation example 1 of the full bridge type DC-DC converter in FIG. 1;

FIG. 3 is a diagram illustrating a timing chart for explaining an operation example 2 of the full bridge type DC-DC converter in FIG. 1;

FIG. 4 is a diagram illustrating a configuration example of a full bridge type DC-DC converter according to a comparative example for an embodiment 1 of the present invention;

FIG. 5 is a diagram illustrating a configuration example of a full bridge type DC-DC converter according to the embodiment 1 of the present invention;

FIGS. 6A and 6B are diagrams illustrating waveforms of a voltage applied to a primary winding of a transformer;

FIG. 7 is a diagram illustrating a configuration example of a full bridge type DC-DC converter according to a modification of the embodiment 1;

FIG. 8 is a diagram illustrating a basic configuration example of a two-transistor forward type DC-DC converter of active clamp system;

FIGS. 9A to 9F are diagrams illustrating timing charts for explaining an operation example of the two-transistor forward type DC-DC converter of active clamp system illustrated in FIG. 8;

FIG. 10 is a diagram illustrating a configuration example of a two-transistor forward type DC-DC converter of active clamp system according to a comparative example for an embodiment 2 of the present invention;

FIG. 11 is a diagram illustrating a configuration example of a two-transistor forward type DC-DC converter of active clamp system according to the embodiment 2 of the present invention;

FIGS. 12A and 12B are diagrams illustrating a waveform of a voltage applied to a primary winding of a transformer; and

FIG. 13 is a diagram illustrating a configuration example of a two-transistor forward type DC-DC converter of active clamp system according to a modification of the embodiment 2.

### DETAILED DESCRIPTION OF THE INVENTION

The invention will now be described by reference to the preferred embodiments. This does not intend to limit the scope of the present invention, but to exemplify the intention.

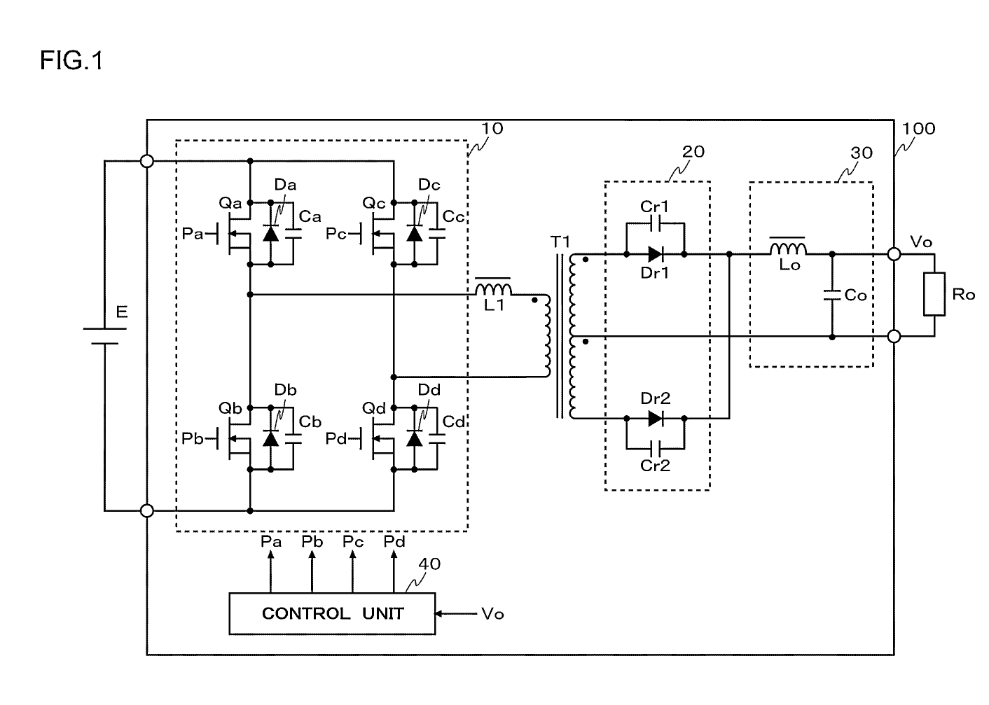

FIG. 1 is a diagram illustrating a basic configuration example of a full bridge type DC-DC converter 100. This full bridge type DC-DC converter 100 is a full bridge type DC-DC converter of phase shift system. The full bridge type DC-DC converter of phase shift system can convert large power with a high efficiency.

The full bridge type DC-DC converter 100 illustrated in FIG. 1 includes a full bridge circuit 10, a first resonance inductor L1, a transformer T1, a rectifier circuit 20, a smoothing circuit 30, and a control unit 40. The full bridge circuit 10 includes a first arm including a first switching element Qa on an upper side and a second switching element Qb on a lower side, and a second arm including a third switching element Qc on an upper side and a fourth switching element Qd on a lower side. The first arm and the second arm are connected in parallel with a DC power supply E. As the first switching element Qa to the fourth switching element Qd, semiconductor switching elements such as, for example, Metal Oxide Semiconductor Field Effect Transistors (MOSFETs) are used. Hereafter, it is supposed that N-channel MOSFETs are used as the first switching element Qa to the fourth switching element Qd.

A first parasitic diode Da and a first parasitic capacitance Ca are formed in parallel with the first switching element Qa. Since an N-channel MOSFET is used as the first switching element Qa, the first parasitic diode Da is formed in a direction opposite to a conduction direction of the first switching element Qa. In other words, the first parasitic diode Da is formed to have a source-to-drain direction as a forward direction. The first parasitic capacitance Ca is an output capacitance Coss formed when the drain of the first switching element Qa is short-circuited to the source in an AC manner.

In the same way, a second parasitic diode Db and a second parasitic capacitance Cb are formed in parallel with the second switching element Qb. In the same way, a third parasitic diode Dc and a third parasitic capacitance Cc are formed in parallel with the third switching element Qc. In the same way, a fourth parasitic diode Dd and a fourth parasitic capacitance Cd are formed in parallel with the fourth switching element Qd.

A first control pulse signal Pa to a fourth control pulse signal Pd generated by the control unit 40 are input to control terminals (gate terminals in the case of MOSFETs) of the first switching element Qa to the fourth switching element Qd, respectively. Upon receiving the first control pulse signal Pa to the fourth control pulse signal Pd, the full bridge circuit 10 switches DC power from the DC power supply E and converts the DC power to AC power.

The transformer T1 transforms output power of the full bridge circuit 10 in accordance with a winding ratio between a primary winding and a secondary winding, and insulates the primary side and the secondary side from each other. An upper terminal of the primary winding of the transformer T1 is connected to an output terminal of the first arm in the full bridge circuit 10 via a first resonance inductor L1. A lower terminal of the primary winding of the transformer T1 is connected to an output terminal of the second arm in the full bridge circuit 10.

The rectifier circuit 20 is connected to the secondary winding of the transformer T1, and rectifies output power of the transformer T1. The rectifier circuit 20 includes a first rectifier diode Dr1 and a second rectifier diode Dr2. A first secondary side parasitic capacitance Cr1 is formed in parallel with the first rectifier diode Dr1, and a second secondary side parasitic capacitance Cr2 is formed in parallel with the second rectifier diode Dr2.

An anode terminal of the first rectifier diode Dr1 is connected to an upper terminal of the secondary winding of the transformer T1. An anode terminal of the second rectifier diode Dr2 is connected to a lower terminal of the secondary winding of the transformer T1. A cathode terminal of the first rectifier diode Dr1 and a cathode terminal of the second rectifier diode Dr2 are connected together and connected to a high voltage side input terminal of the smoothing circuit 30. A middle point of the secondary winding of the transformer T1 is connected to a low voltage side input terminal of the smoothing circuit 30.

The smoothing circuit 30 smoothes power rectified by the rectifier circuit 20, and supplies the smoothed power to an external load Ro. The smoothing circuit 30 includes an output inductance Lo and an output capacitance Co to smooth the output power of the rectifier circuit 20.

The control unit 40 generates a first control pulse signal Pa to a fourth control pulse signal Pd to be input respectively to the control terminals of the first switching element Qa to the fourth switching element Qd, and drives the full bridge circuit 10 with a phase shift system. After the first parasitic capacitance Ca of the first switching element Qa is discharged by a current based upon energy in the first resonance inductor L1, the control unit 40 turns ON the first switching element Qa. The same is also true for the second switching element Qb to the fourth switching element Qd.

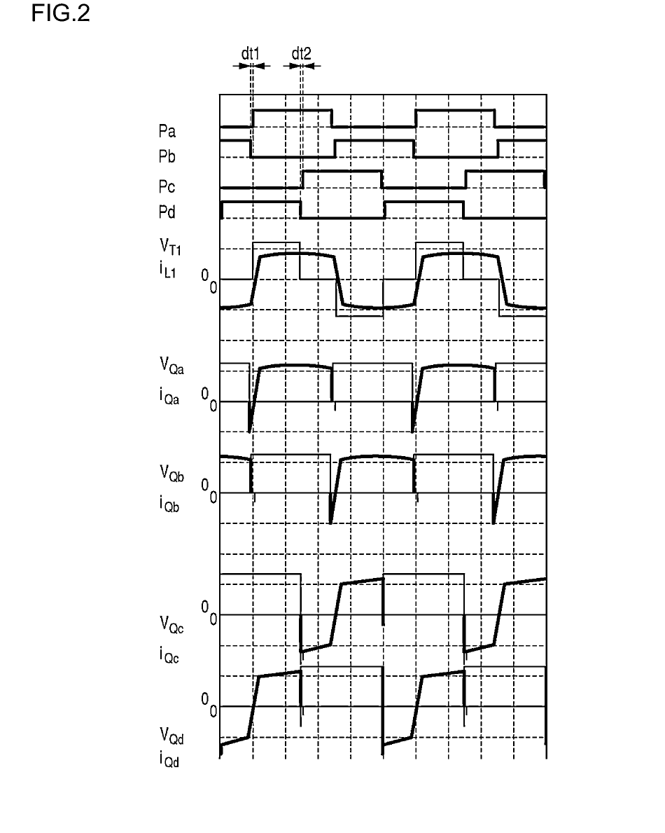

FIG. 2 is a diagram illustrating a timing chart for explaining an operation example 1 of the full bridge type DC-DC converter 100 in FIG. 1. The operation example 1 is an operation example of a general phase shift system. In the full bridge circuit, a positive direction voltage is applied to the transformer T1 when the first switching element Qa and the fourth switching element Qd are ON and the second switching element Qb and the third switching element Qc are OFF. On the contrary, a negative direction voltage is applied to the transformer T1 when the first switching element Qa and the fourth switching element Qd are OFF and the second switching element Qb and the third switching element Qc are ON.

In a hard switching system, an output voltage Vo is adjusted by adjusting an ON time for a unit period T, i.e., by adjusting a duty ratio. On the other hand, in the phase shift system according to the operation example 1, the duty ratio of the first control pulse signal Pa to the fourth control signal Pd is 50% and fixed. The first switching element Qa and the second switching element Qb operate complementarily except dead time. In the same way, the third switching element Qc and the fourth switching element Qd also operate complementarily except dead time.

Premised on the foregoing description, the output voltage Vo is adjusted by adjusting a phase difference between a pulse phase of the first arm including the first switching element Qa and the second switching element Qb and a pulse phase of the second arm including the third switching element Qc and the fourth switching element Qd. Specifically, the control unit compares the output voltage Vo which is output to the load Ro with a target voltage, and adaptively shifts the pulse phase of the second arm as compared with the pulse phase of the first arm to make both voltages to become closer. If the phase difference between the pulse phase of the first arm and the pulse phase of the second arm changes, an amount of a current flowing through the primary winding of the transformer T1 can be adjusted. As a result, the output voltage Vo can be adjusted.

In FIG. 2, a waveform of the first control pulse signal Pa which is input to the first switching element Qa, a waveform of the second control pulse signal Pb which is input to the second switching element Qb, a waveform of the third control pulse signal Pc which is input to the third switching element Qc, and a waveform of the fourth control pulse signal Pd which is input to the fourth switching element Qd are illustrated in order from the top. Dead time is provided at each of time of phase reversal of the first switching element Qa and the second switching element Qb and time of phase reversal of the third switching element Qc and the fourth switching element Qd.

Subsequently, a waveform of a voltage V_{T1} applied to the primary winding of the transformer T1, and a waveform of a current i_{L1} flowing through the first resonance inductor L1 are illustrated. Hereafter, each current waveform is drawn with a thick line. Subsequently, a waveform of a voltage V_{Qa} applied across the first switching element Qa and a waveform of a current i_{Qa} flowing through the first switching element Qa are illustrated. Subsequently, a waveform of a voltage V_{Qb} applied across the second switching element Qb and a waveform of a current i_{Qb} flowing through the second switching element Qb are illustrated. Subsequently, a waveform of a voltage V_{Qc} applied across the third switching element Qc and a waveform of a current i_{Qc} flowing through the third switching element Qc are illustrated. Finally, a waveform of a voltage V_{Qd} applied across the fourth switching element Qd and a waveform of a current i_{Qd} flowing through the fourth switching element Qd are illustrated.

An initial state of the timing chart in FIG. 2 is a state in which the first switching element Qa and a third switching element Qc are OFF and the second switching element Qb and the fourth switching element Qd are ON. In this state, a negative current flows through the first resonance inductor L1, a positive current flows through the second switching element Qb, and a negative current flows through the fourth switching element Qd. The first parasitic capacitance Ca and the third parasitic capacitance Cc are in a charged state.

From this state, a phase of the first arm is inverted. At that time, a dead time dt1 is provided. In other words, the dead time dt1 is inserted after the second switching element Qb turns OFF, and the first switching element Qa turns ON after end of the dead time dt1. During the dead time dt1, the current is maintained by energy stored in the first resonance inductor L1, and a negative current flows through the first switching element Qa. Charge stored in the first parasitic capacitance Ca is discharged by this negative current. Thereafter, the first switching element Qa is turned ON, and consequently a switching loss due to the charge stored in the first parasitic capacitance Ca is not caused.

Since a switching loss Pc is defined by the following Expression (1), the switching loss Pc can be made small as an output capacitance Coss of a switching element is made small.

Pc=1/2·Coss·V²·f Expression (1)

Wherein V is a voltage applied to the switching element, and f is a switching frequency.

Furthermore, a zero voltage resonance condition can be defined by the following Expression (2).

L·It²>Coss·V² Expression (2)

Wherein L is inductance of a resonance inductor, and It is a current flowing through the resonance inductor.

If the relation in the Expression (2) is satisfied, the zero voltage resonance becomes possible. Therefore, it is necessary to provide a resonance inductor that is sufficiently large as compared with the output capacitance Coss of the switching element. The first resonance inductor L1 in FIG. 1 may be composed of a leak inductance of the primary winding of the transformer T1. If the relation in the Expression (2) is not satisfied, however, it becomes impossible to implement complete zero voltage switching. In a use in which the output capacitance Coss of the switching element becomes large, therefore, it is preferable to provide an inductor element apart from the primary winding.

Referring back to FIG. 2, inversion of the phase of the first arm brings about a state in which the first switching element Qa and the fourth switching element Qd are ON and the second switching element Qb and the third switching element Qc are OFF. In this state, a positive voltage is applied to the primary winding of the transformer T1, a positive current flows through the first resonance inductor L1, a positive current flows through the first switching element Qa, and a positive current flows through the fourth switching element Qd. The second parasitic capacitance Cb and the third parasitic capacitance Cc are in a charged state.

From this state, a phase of the second arm is inverted. At that time, a dead time dt2 is provided. In other words, the dead time dt2 is inserted after the fourth switching element Qd turns OFF, and the third switching element Qc turns ON after end of the dead time dt2. During the dead time dt2, the current is maintained by energy stored in the first resonance inductor L1, and a negative current flows through the third switching element Qc. Charge stored in the third parasitic capacitance Cc is discharged by this negative current. Thereafter, the third switching element Qc is turned ON, and consequently a switching loss due to the charge stored in the third parasitic capacitance Cc is not caused. Because of a similar principle, a switching loss is not caused when the second switching element Qb turns ON and when the fourth switching element Qd turns ON, either. As described heretofore, zero voltage switching in the full bridge circuit 10 is implemented.

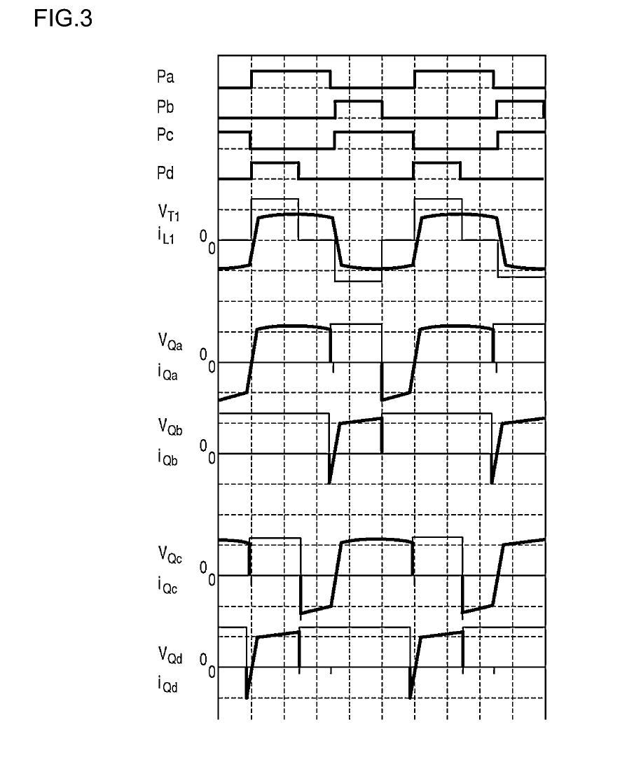

FIG. 3 is a diagram illustrating a timing chart for explaining an operation example 2 of the full bridge type DC-DC converter 100 in FIG. 1. The operation example 2 is a modification in which the same power as that in the operation example 1 is supplied to the transformer T1 by using a first control pulse signal Pa to a fourth control signal Pd which are different from those in the operation example 1. In a phase shift system according to the operation example 2, a duty ratio of the first control pulse signal Pa and the third control pulse signal Pc is 50% and fixed. A duty ratio of the second control pulse signal Pb and the fourth control pulse signal Pd is about 25% and fixed. The first switching element Qa and the third switching element Qc operate complementarily except dead time. The second switching element Qb and the fourth switching element Qd operate with a phase difference of 180°. A rising phase of the first switching element Qa and a rising phase of the fourth switching element Qd synchronize with each other, and a rising phase of the second switching element Qb and a rising phase of the third switching element Qc synchronize with each other. As a result, a voltage V_{T1} applied to the primary winding having a waveform similar to that in the phase shift system according to the operation example 1 can be generated.

Waveforms of voltages V_{Qa} to V_{Qd} applied respectively across the first switching element Qa to the fourth switching element Qd, and waveforms of currents i_{Qa} to i_{Qd} flowing respectively through the first switching element Qa to the fourth switching element Qd are illustrated in FIG. 3, and detailed description will be omitted. The first switching element Qa to the fourth switching element Qd are turned ON in a state in which the first parasitic capacitance Ca to the fourth parasitic capacitance Cd are discharged respectively and no charge is stored. As a result, zero voltage switching of the full bridge circuit 10 is implemented.

The full bridge type DC-DC converter 100 illustrated in FIG. 1 is a highly efficient switching power supply apparatus as described heretofore. However, the full bridge type DC-DC converter 100 illustrated in FIG. 1 has a problem described hereafter. In other words, the problem is that a surge voltage is caused by resonance between the first resonance inductor L1 and the first secondary side parasitic capacitance Cr1 and the second secondary side parasitic capacitance Cr2. If this surge voltage exceeds withstand voltages of various elements in the full bridge type DC-DC converter 100, there is a possibility that troubles might be caused in the various elements. Furthermore, the voltage and current supplied to the primary winding of the transformer T1 vibrate because of resonance and a power loss is caused.

The first secondary side parasitic capacitance Cr1 and the second secondary side parasitic capacitance Cr2 are converted to a capacitance CO on the primary side by the following Expression (3).

C0=N²·Cr

N=N2/N1 Expression (3)

Wherein N1 is the number of turns on the primary winding of the transformer T1, and N2 is the number of turns on the secondary winding. Cr is one capacitance of the first secondary side parasitic capacitance Cr1 and the second secondary side parasitic capacitance Cr2.

Hereafter, a contrivance for suppressing the resonance between the first resonance inductor L1 and the first secondary side parasitic capacitance Cr1 and the second secondary side parasitic capacitance Cr2 will be considered.

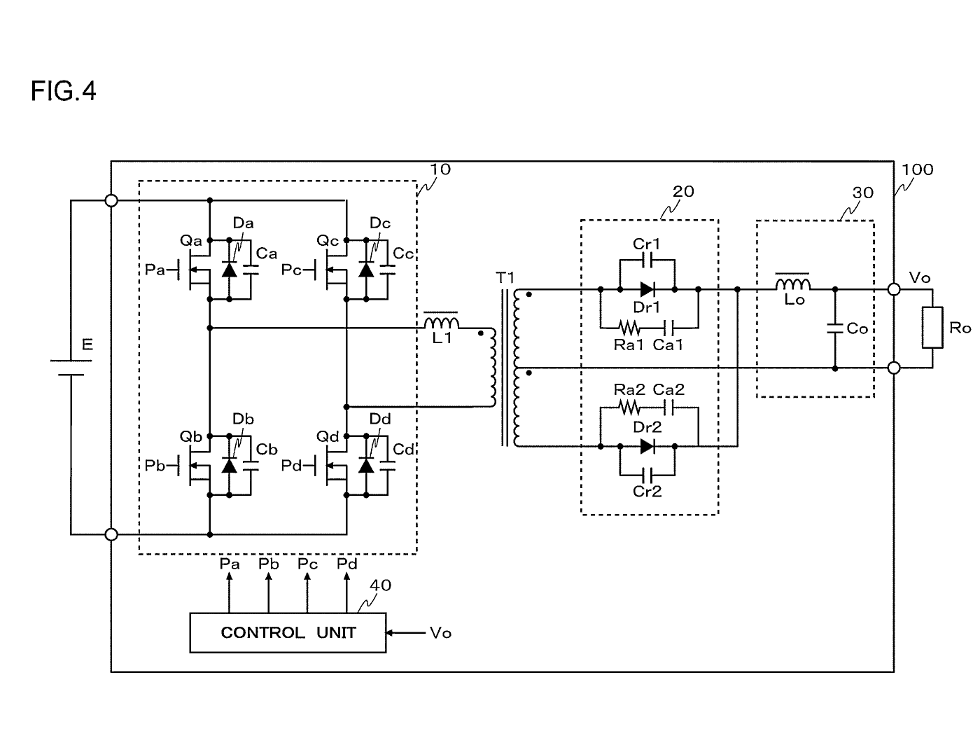

FIG. 4 is a diagram illustrating a configuration example of a full bridge type DC-DC converter 100 according to a comparative example for an embodiment 1 of the present invention. This full bridge type DC-DC converter 100 has a configuration obtained by connecting a CR absorber in parallel with each of the first rectifier diode Dr1 and the second rectifier diode Dr2 in the full bridge type DC-DC converter 100 illustrated in FIG. 1. Specifically, a series circuit of a first protective resistor Ra1 and a first protective capacitance Ca1 is connected in parallel with the first rectifier diode Dr1. In the same way, a series circuit of a second protective resistor Ra2 and a second protective capacitance Ca2 is connected in parallel with the second rectifier diode Dr2. The first protective capacitance Ca1 and the second protective capacitance Ca2 absorb a high frequency surge voltage.

If CR absorbers are provided, however, the size of the circuit becomes large. Furthermore, the CR absorbers are insufficient to hold down the power loss caused by vibration.

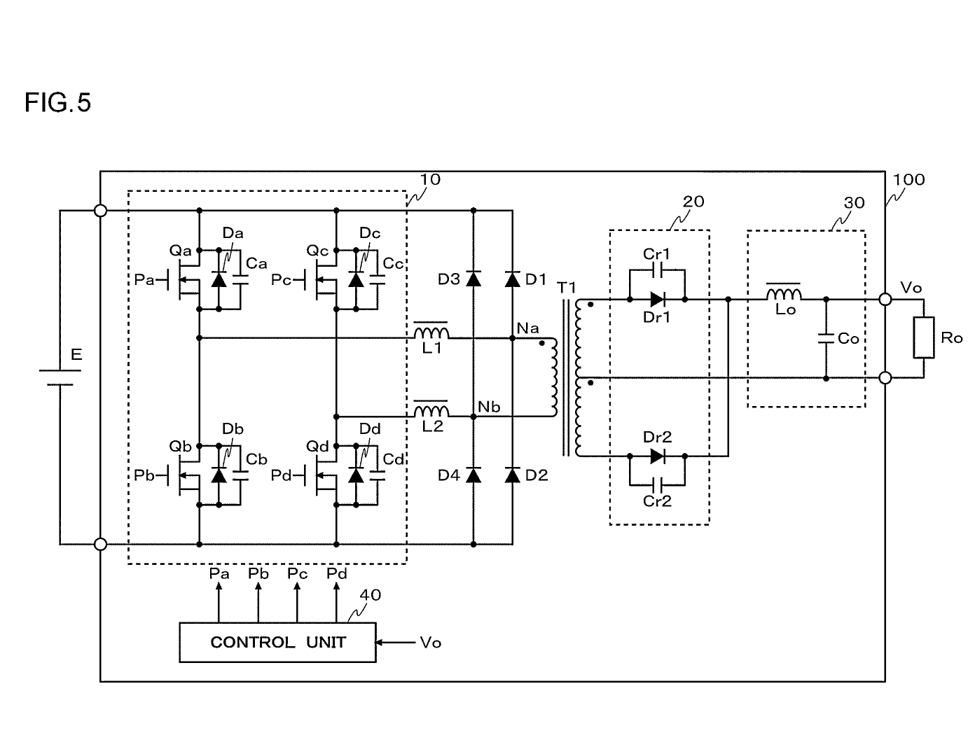

FIG. 5 is a diagram illustrating a configuration example of a full bridge type DC-DC converter 100 according to an embodiment 1 of the present invention. This full bridge type DC-DC converter 100 has a configuration obtained by adding a second resonance inductor L2 and a first protective diode D1 to a fourth protective diode D4 to the primary side of the full bridge type DC-DC converter 100 illustrated in FIG. 1.

The second resonance inductor L2 is connected between the output terminal of the second arm in the full bridge circuit 10 and the lower terminal of the primary winding of the transformer T1. The first protective diode D1 is connected between a first node Na of the first resonance inductor L1 and the upper terminal of the primary winding of the transformer T1, and a power line on a high voltage side of the DC power supply E. Specifically, an anode terminal of the first protective diode D1 is connected to the first node Na, and a cathode terminal is connected to the power line. The second protective diode D2 is connected between the first node Na and a power line on a low voltage side of the DC power supply E. Specifically, a cathode terminal of the second protective diode D2 is connected to the first node Na, and an anode terminal is connected to the power line.

The third protective diode D3 is connected between a second node Nb between the second resonance inductor L2 and the lower terminal of the primary winding of the transformer T1, and the power line on the high voltage side of the DC power supply E. Specifically, an anode terminal of the third protective diode D3 is connected to the second node Nb, and a cathode terminal is connected to the power line. The fourth protective diode D4 is connected between the second node Nb and the power line on the low voltage side of the DC power supply E. Specifically, a cathode terminal of the fourth protective diode D4 is connected to the second node Nb, and an anode terminal is connected to the power line.

As a result, an upper limit voltage and a lower limit voltage at the two nodes Na and Nb can be clamped to the power line on the high voltage side and the power line on the low voltage side of the DC power supply E. In other words, a surge voltage generated at the two nodes Na and Nb can be fed back to the DC power supply E via the first protective diode D1 to the fourth protective diode D4.

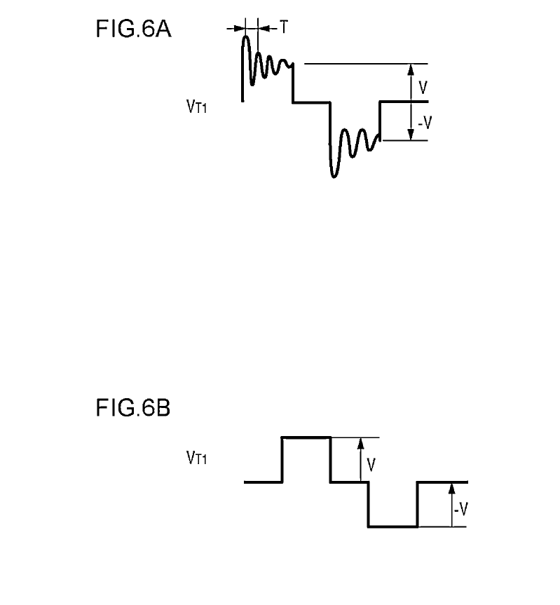

FIGS. 6A and 6B are diagrams illustrating waveforms of a voltage V_{T1} applied to the primary winding of the transformer T1. FIG. 6A illustrates a waveform in the full bridge type DC-DC converter 100 that is not provided with a countermeasure against resonance illustrated in FIG. 1. FIG. 6B illustrates a waveform in the full bridge type DC-DC converter 100 provided with a countermeasure against resonance illustrated in FIG. 5.

In FIG. 6A, the voltage V_{T1} applied to the primary winding vibrates because of resonance between the first resonance inductor L1 and the first secondary side parasitic capacitance Cr1 and the second secondary side parasitic capacitance Cr2. Peak voltages of the voltage V_{T1} exceed a voltage range −V to +V of the DC power supply E.

A frequency f of this vibration is defined by the following Expression (4), and a period T of the vibration is defined by the following Expression (5).

f=1/(2π√(L1·C0)) Expression (4)

T=1/f Expression (5)

In FIG. 6B, the voltage V_{T1} applied to the primary winding is clamped to a voltage on the power line on the high voltage side and a voltage on the power line on the low voltage side of the DC power supply E by the first protective diodes D1 to the fourth protective diode D4. As a result, vibration can be suppressed.

According to the embodiment 1 of the present invention, diodes are connected in opposite directions between the node between the resonance inductor on the primary side and the primary winding of the transformer, and power supply voltage lines as described heretofore. As a result, it is possible to reduce the influence of resonance caused by the resonance inductor on the primary side and the capacitance components on the secondary side. Since a surge voltage caused by the resonance can be suppressed, various elements in the full bridge type DC-DC converter 100 can be protected. Since it is not necessary to raise withstand voltages of the various elements, it is possible to prevent elements from becoming large sized and high in cost. Furthermore, since vibration caused by the resonance can be suppressed, a power loss caused by vibration can be suppressed and lowering in conversion efficiency can be prevented.

Heretofore, the embodiment 1 of the present invention has been described. The embodiment 1 is an example. It will be appreciated by those skilled in the art that various modifications are possible in combinations of components and processing processes and such modifications are also within the scope of the present embodiment.

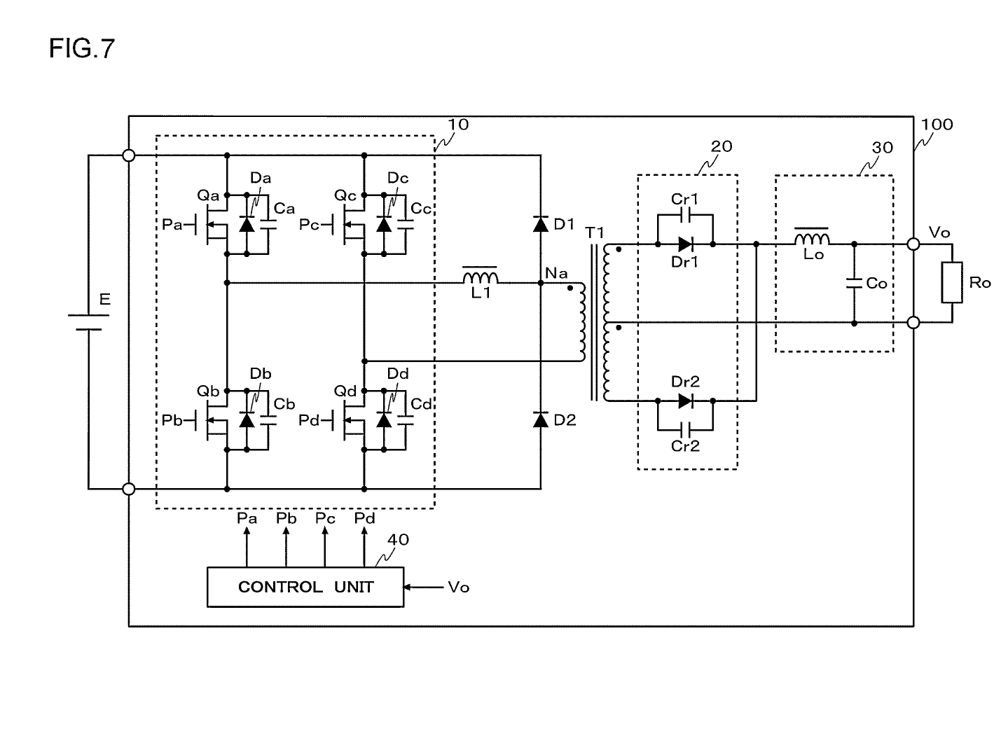

FIG. 7 is a diagram illustrating a configuration example of a full bridge type DC-DC converter 100 according to a modification of the embodiment 1. The full bridge type DC-DC converter 100 according to the present modification has a configuration obtained by removing the second resonance inductor L2, the third protective diode D3 and the fourth protective diode D4 from the full bridge type DC-DC converter 100 illustrated in FIG. 5. Even if a protective diode is connected to only one terminal of the primary winding of the transformer T1, a certain resonance suppression effect is obtained. Furthermore, if the CR absorbers on the secondary side illustrated in the full bridge type DC-DC converter 100 in FIG. 4 are used together, the resonance suppression effect can be further enhanced.

Furthermore, an example in which the rectifier circuit 20 includes the first rectifier diode Dr1 and the second rectifier diode Dr2 has been described in the embodiment 1. Instead of them, however, switching elements such as MOSFETs may be used. In this case as well, resonance is caused between parasitic capacitance of the switching element and the resonance inductor on the primary side. However, the influence of the resonance can be reduced by the first protective diode D1 to the fourth protective diode D4.

Furthermore, an example in which a parasitic capacitance and a parasitic diode are formed in parallel with a switching element has been described. However, a capacitance element and/or a diode element may be connected in parallel with the switching element.

Furthermore, instead of the DC power supply E which supplies the input voltage to the full bridge circuit 10, an AC power supply, a rectifier circuit, and a Power Factor Correction (PFC) circuit may be used.

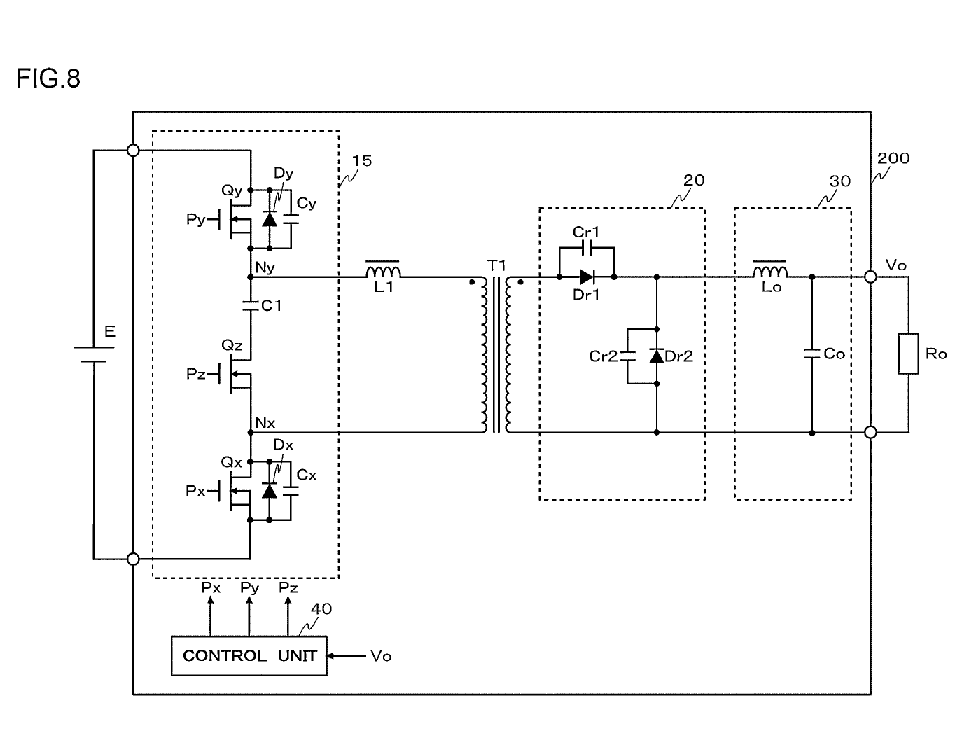

FIG. 8 is a diagram illustrating a basic configuration example of a two-transistor forward type DC-DC converter 200 of active clamp system. The two-transistor forward type DC-DC converter 200 of active clamp system is a switching power supply apparatus of zero voltage switching system. The forward type DC-DC converter of active clamp system has a configuration obtained by replacing a demagnetizing diode on the primary side of an ordinary forward type DC-DC converter with a capacitance and a switching element.

The DC-DC converter 200 in FIG. 8 includes a two-transistor forward type switching circuit 15, a resonance inductor L1, a transformer T1, a rectifier circuit 20, a smoothing circuit 30, and a control unit 40. The two-transistor forward type switching circuit 15 includes a first main switching element Qx, a second main switching element Qy, an auxiliary switching element Qz, and a clamp capacitance C1.

The first main switching element Qx is connected between the power line on the low voltage side of the DC power supply E and a node Nx to which a path to the lower terminal of the primary winding of the transformer T1 is connected. The second main switching element Qy is connected between the power line on the high voltage side of the DC power supply E and a node Ny to which a path to the upper terminal of the primary winding of the transformer T1 is connected. A clamp circuit formed by connecting the auxiliary switching element Qz and the clamp capacitance C1 in series is connected between the node Nx and the node Ny.

The second main switching element Qy is a configuration added in the two-transistor type, and it is removed in the one-transistor forward type. As compared with the one-transistor forward type, in the two-transistor forward type, the input voltage is divided by two switching elements and switching can be conducted. As compared with the case where switching is conducted with one switching element, therefore, withstand voltage of one switching element can be lowered. For example, in the case where the input voltage is 400 V, it is necessary in the one-transistor forward type to use a switching element having a withstand voltage of at least 800 V. In the two-transistor type, however, a switching element having a withstand voltage of at least 400 V suffices. If a switching element having a low withstand voltage is used, the ON-resistance can be lowered. In this way, the two-transistor forward type is suitable for applications in which the input voltage is high.

As the first main switching element Qx, the second main switching element Qy, and the auxiliary switching element Qz, semiconductor switching elements, such as, for example, Metal Oxide Semiconductor Field Effect Transistors (MOSFETs) are used. Hereafter, it is supposed that N-channel MOSFETs are used as the first main switching element Qx, the second main switching element Qy, and the auxiliary switching element Qz.

A first main element parasitic diode Dx and a first main element parasitic capacitance Cx are formed in parallel with the first main switching element Qx. Since an N-channel MOSFET is used as the first main switching element Qx, the first main element parasitic diode Dx is formed in a direction opposite to a conduction direction of the first main switching element Qx. In other words, the first main element parasitic diode Dx is formed to have a source-to-drain direction as a forward direction. The first main element parasitic capacitance Cx is an output capacitance Coss formed in a case where a path between the drain and the source of the first main switching element Qx is short-circuited in an AC manner.

In the same way, a second main element parasitic diode Dy and a second main element parasitic capacitance Cy are formed in parallel with the second main switching element Qy. By the way, in the present specification, a parasitic diode and a parasitic capacitance formed in parallel with the auxiliary switching element Qz are disregarded in order to make description intelligible.

Control pulse signals Px, Py and Pz generated by the control unit 40 are input to control terminals (gate terminals in the case of MOSFETs) of the first main switching element Qx, the second main switching element Qy, and the auxiliary switching element Qz, respectively. The two-transistor forward type switching circuit 15 receives the control pulse signals Px, Py and Pz, switches DC power from the DC power supply E, and converts the DC power to AC power.

The transformer T1 transforms the output power of the two-transistor forward type switching circuit 15 in accordance with a winding ratio between the primary winding and the secondary winding, and insulates the primary side and the secondary side from each other. The resonance inductor L1 is connected between the two-transistor forward type switching circuit 15 and the primary winding of the transformer T1. Specifically, the resonance inductor L1 is connected between the node Ny in the two-transistor forward type switching circuit 15 and the upper terminal of the primary winding of the transformer T1. The lower terminal of the primary winding of the transformer T1 is connected to the node Nx in the two-transistor forward type switching circuit 15.

By the way, the resonance inductor L1 may be connected between the node Nx in the two-transistor forward type switching circuit 15 and the lower terminal of the primary winding of the transformer T1. In that case, the upper terminal of the primary winding of the transformer T1 is connected directly to the node Nx in the two-transistor forward type switching circuit 15.

The rectifier circuit 20 is connected to the secondary winding of the transformer T1, and rectifies the output power of the transformer T1. The rectifier circuit 20 includes a first rectifier diode Dr1 and a second rectifier diode Dr2. A first secondary side parasitic capacitance Cr1 is formed in parallel with the first rectifier diode Dr1, and a second secondary side parasitic capacitance Cr2 is formed in parallel with the second rectifier diode Dr2.

An anode terminal of the first rectifier diode Dr1 is connected to an upper terminal of the secondary winding of the transformer T1. An anode terminal of the second rectifier diode Dr2 is connected to a lower terminal of the secondary winding of the transformer T1. A cathode terminal of the first rectifier diode Dr1 and a cathode terminal of the second rectifier diode Dr2 are connected together, and connected to a high voltage side input terminal of the smoothing circuit 30. A low voltage side input terminal of the smoothing circuit 30 is connected to the lower terminal of the secondary winding of the transformer T1.

The smoothing circuit 30 smoothes power rectified by the rectifier circuit 20 and supplies the smoother power to an external load Ro. The smoothing circuit 30 includes an output inductance Lo and an output capacitance Co to smooth the output power of the rectifier circuit 20.

The control unit 40 generates the control pulse signals Px, Py and Pz to be input respectively to the control terminals of the first main switching element Qx, the second main switching element Qy, and the auxiliary switching element Qz, and drives the two-transistor forward type switching circuit 15. The control unit 40 drives the first main switching element Qx and the second main switching element Qy with the same phase. The control unit 40 drives the first main switching element Qx and the second main switching element Qy, and the auxiliary switching element Qz basically complementarily. By the way, although details will be described later, an interval during which all of the first main switching element Qx, the second main switching element Qy, and the auxiliary switching element Qz are OFF is also provided.

After the first main element parasitic capacitance Cx and the second main element parasitic capacitance Cy are discharged by a current based upon energy in the resonance inductor L1, the control unit 40 turns ON the first main switching element Qx and the second main switching element Qy. As a result, zero voltage switching is implemented.

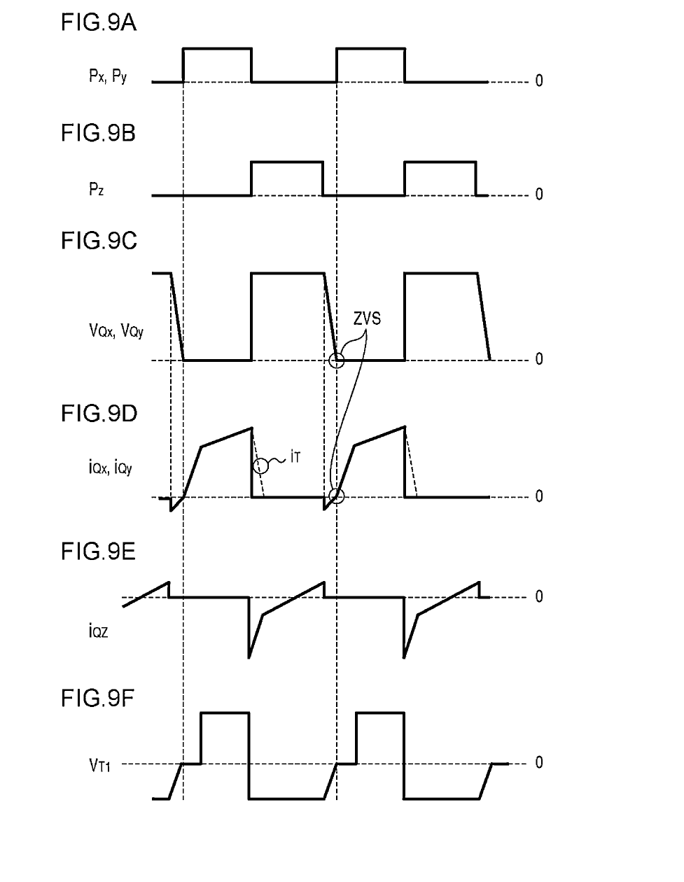

FIGS. 9A to 9F are diagrams illustrating timing charts for explaining an operation example of the two-transistor forward type DC-DC converter 200 of the active clamp system illustrated in FIG. 8. FIG. 9A illustrates the control pulse signals Px and Py which are input respectively to the first main switching element Qx and the second main switching element Qy. FIG. 9B illustrates the control pulse signal Pz which is input to the auxiliary switching element Qz. FIG. 9C illustrates drain-source voltages V_{Qx} and V_{Qy} respectively of the first main switching element Qx and the second main switching element Qy. FIG. 9D illustrates currents i_{Qx} and i_{Qy} flowing from a drain to a source of the first main switching element Qx and the second main switching element Qy, respectively. FIG. 9E illustrates a current i_{Qz} flowing from a drain to a source of the auxiliary switching element Qz. FIG. 9F illustrates a voltage V_{T1} applied to the primary winding of the transformer T1.

First, a state in which the control pulse signals Px and Py are at a high level and the control pulse signal Pz is at a low level will now be described. In this state, conduction is obtained between the drain and the source in the first main switching element Qx and the second main switching element Qy, and the currents i_{Qx} and i_{Qy} flow from the drain to the source in the first main switching element Qx and the second main switching element Qy, respectively. The currents i_{Qx} and i_{Qy} become gradually large as the time elapses. The auxiliary switching element Qz does not conduct, and the current i_{Qz} does not flow between the drain and the source of the auxiliary switching element Qz. A positive voltage V_{T1} is applied to the primary winding of the transformer T1.

Then, the control pulse signals Px and Py invert to become the low level state and the control pulse signal Pz inverts to become the high level state. In this state, non-conduction is brought about between the drain and the source in the first main switching element Qx and the second main switching element Qy, and the currents i_{Qx} and i_{Qy} flowing from the drain to the source respectively in the first main switching element Qx and the second main switching element Qy are intercepted. The first main element parasitic capacitance Cx and the second main element parasitic capacitance Cy are charged according to the voltages V_{QX} and V_{Qy} generated between the drain and the source in the first main switching element Qx and the second main switching element Qy, respectively.

Even after the first main switching element Qx and the second main switching element Qy become non-conductive, a current based upon energy stored in the resonance inductor L1 flows to the node Nx via the primary winding of the transformer T1. Since the auxiliary switching element Qz is conducting, the current i_{T} flows from the source to the drain in the auxiliary switching element Qz, and the clamp capacitance C1 is charged. If charging the clamp capacitance C1 advances and a voltage across the clamp capacitance C1 inverts, a current based upon charge stored in the clamp capacitance C1 flows backward to the resonance inductor L1 via the auxiliary switching element Qz and the primary winding of the transformer T1. A negative voltage V_{T1} is applied to the primary winding of the transformer T1.

Then, the control pulse signals Px and Py are switched to the low level state and the control pulse signal Pz is switched to the low level state. In this state, the auxiliary switching element Qz becomes non-conductive. As a result, the current i_{Qz} does not flow between the drain and the source in the auxiliary switching element Qz. Charges stored in the first main element parasitic capacitance Cx and the second main element parasitic capacitance Cy are discharged by the current i_{T} based upon energy stored in the resonance inductor L1. If these charges are discharged completely, the drain-source voltages V_{Qx} and VQy respectively in the first main switching element Qx and the second main switching element Qy become zero. The voltage V_{T1} on the primary winding of the transformer T1 also becomes zero if the excited current i_{T} disappears.

Then, the control pulse signals Px and Py are switched to the high level state and the control pulse signal Pz is switched to the low level state. At the time of this switching, the first main element parasitic capacitance Cx and the second main element parasitic capacitance Cy do not hold charge. The drain-source voltages V_{Qx} and V_{Qy} respectively in the first main switching element Qx and the second main switching element Qy are zero (ZVS). As a result, zero voltage switching can be implemented. In other words, a switching loss caused by charges stored in the first main element parasitic capacitance Cx and the second main element parasitic capacitance Cy does not occur.

The switching loss Pc is defined by the following Equation (6). As the output capacitance Coss of a switching element is made small, the switching loss Pc can be made small.

Pc=1/2·Coss·V²·f Expression (6)

Wherein V is a voltage applied to the switching element, and f is a switching frequency.

Furthermore, a zero voltage resonance condition can be defined by the following Expression (7).

L·It²>Coss·V² Expression (7)

Wherein L is inductance of a resonance inductor, and It is a current flowing through the resonance inductor.

If the relation in the Expression (7) is satisfied, the zero voltage resonance becomes possible. Therefore, it is necessary to provide a resonance inductor that is sufficiently large as compared with the output capacitance Coss of the switching element. The resonance inductor L1 in FIG. 8 may be composed of a leak inductance of the primary winding of the transformer T1. If the relation in the Expression (7) is not satisfied, however, it becomes impossible to implement complete zero voltage switching. In a use in which the output capacitance Coss of the switching element becomes large, therefore, it is preferable to provide an inductor element apart from the primary winding.

The two-transistor forward type DC-DC converter 200 of active clamp system illustrated in FIG. 8 is a highly efficient switching power supply apparatus as described heretofore. However, the two-transistor forward type DC-DC converter 200 of active clamp system has a problem described hereafter. In other words, the problem is that a surge voltage is caused by resonance between the resonance inductor L1 and the first secondary side parasitic capacitance Cr1 and the second secondary side parasitic capacitance Cr2. If this surge voltage exceeds withstand voltages of various elements in the DC-DC converter 200, there is a possibility that troubles might be caused in the various elements. Furthermore, the voltage and current supplied to the primary winding of the transformer T1 vibrate because of resonance and a power loss is caused.

The first secondary side parasitic capacitance Cr1 and the second secondary side parasitic capacitance Cr2 are converted to a capacitance C0 on the primary side by the following Expression (8).

C0=N²·Cr

N=N2/N1 Expression (8)

Wherein N1 is the number of turns on the primary winding of the transformer T1, and N2 is the number of turns on the secondary winding. Cr is one capacitance of the first secondary side parasitic capacitance Cr1 and the second secondary side parasitic capacitance Cr2.

Hereafter, a contrivance for suppressing the resonance between the resonance inductor L1 and the first secondary side parasitic capacitance Cr1 and the second secondary side parasitic capacitance Cr2 will be considered.

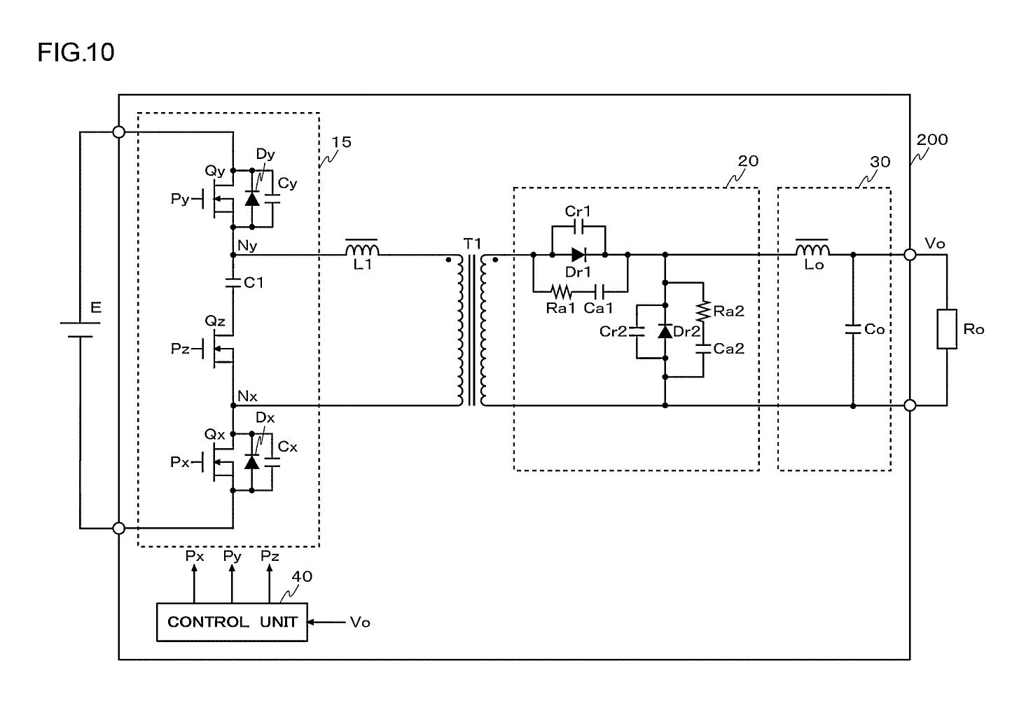

FIG. 10 is a diagram illustrating a configuration example of a two-transistor forward type DC-DC converter 200 of active clamp system according to a comparative example for an embodiment 2 of the present invention. This DC-DC converter 200 has a configuration obtained by connecting a CR absorber in parallel with each of the first rectifier diode Dr1 and the second rectifier diode Dr2 in the DC-DC converter 200 illustrated in FIG. 8. Specifically, a series circuit of a first protective resistor Ra1 and a first protective capacitance Ca1 is connected in parallel with the first rectifier diode Dr1. In the same way, a series circuit of a second protective resistor Ra2 and a second protective capacitance Ca2 is connected in parallel with the second rectifier diode Dr2. The first protective capacitance Ca1 and the second protective capacitance Ca2 absorb a high frequency surge voltage.

If CR absorbers are provided, however, the size of the circuit becomes large. Furthermore, the CR absorbers are insufficient to hold down the power loss caused by vibration.

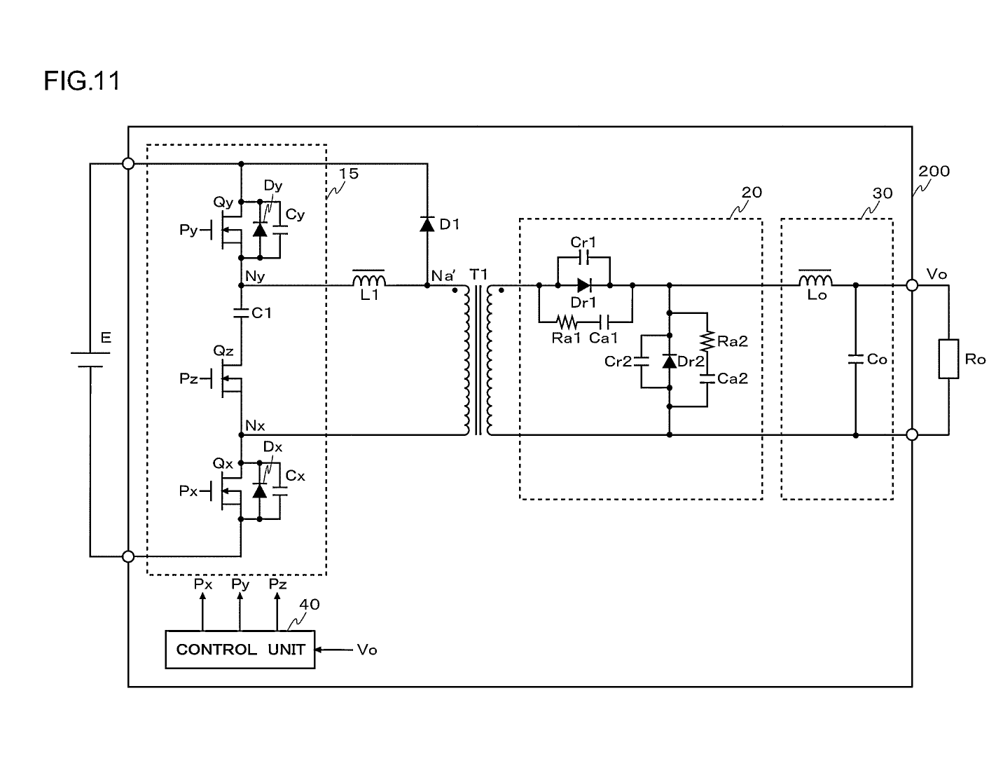

FIG. 11 is a diagram illustrating a configuration example of a two-transistor forward type DC-DC converter 200 of active clamp system according to an embodiment 2 of the present invention. This DC-DC converter 200 has a configuration obtained by adding a protective diode D1 to the primary side of the DC-DC converter 200 illustrated in FIG. 8.

The protective diode D1 is connected between a node Na′ between the resonance inductor L1 and the upper terminal of the primary winding of the transformer T1, and a power line on a high voltage side of the DC power supply E. Specifically, an anode terminal of the protective diode D1 is connected to the node Na′, and a cathode terminal is connected to the power line.

As a result, an upper limit voltage at the node Na′ can be clamped to the power line on the high voltage side of the DC power supply E. In other words, a surge voltage generated at the node Na′ can be fed back to the DC power supply E via the protective diode D1.

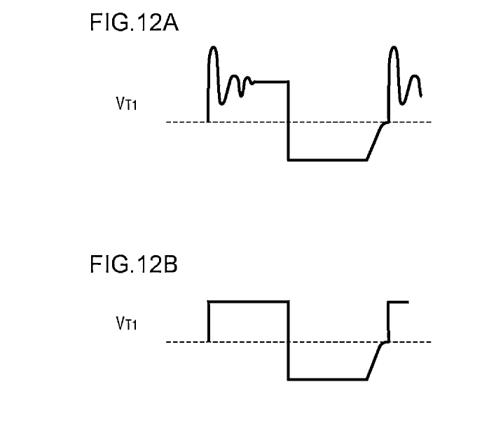

FIGS. 12A and 12B are diagrams illustrating waveforms of a voltage V_{T1} applied to the primary winding of the transformer T1. FIG. 12A illustrates a waveform in the two-transistor forward type DC-DC converter 200 of active clamp system that is not provided with a countermeasure against resonance illustrated in FIG. 8. FIG. 12B illustrates a waveform in the two-transistor forward type DC-DC converter 200 of active clamp system provided with a countermeasure against resonance illustrated in FIG. 11.

In FIG. 12A, the voltage V_{T1} applied to the primary winding (specifically, the voltage V_{T1} at the time when the voltage of the DC power supply E is applied) vibrates because of resonance between the first resonance inductor L1 and the first secondary side parasitic capacitance Cr1 and the second secondary side parasitic capacitance Cr2. A peak voltage of the voltage V_{T1} exceeds the voltage of the DC power supply E.

A frequency f of this vibration is defined by the following Expression (9), and a period T of the vibration is defined by the following Expression (10).

f=1/(2π√(L1·C0)) Expression (9)

T=1/f Expression (10)

In FIG. 12B, the voltage V_{T1} applied to the primary winding is clamped to a voltage on the power line on the high voltage side of the DC power supply E by the protective diode D1. As a result, vibration can be suppressed.

According to the embodiment 2 of the present invention, a diode is connected in an opposite direction between the node between the resonance inductor on the primary side and the primary winding of the transformer, and a power supply voltage line as described heretofore. As a result, it is possible to reduce the influence of resonance caused by the resonance inductor on the primary side and the capacitance components on the secondary side. Since a surge voltage caused by the resonance can be suppressed, various elements in the DC-DC converter 200 can be protected. Since it is not necessary to raise withstand voltages of the various elements, it is possible to prevent elements from becoming large sized and high in cost. Furthermore, since vibration caused by the resonance can be suppressed, a power loss caused by vibration can be suppressed and lowering in conversion efficiency can be prevented.

The forward type DC-DC converter of active clamp system according to the present embodiment is suitable for the two-transistor forward type. In the case of the one-transistor forward type, the second main switching element Qy is removed. Therefore, a current flowing out from the protective diode D1 onto the power line on the high voltage side of the DC power supply E circulates through the node Ny and the resonance inductor L1. In the case of the two-transistor forward type, this circulating current can be intercepted by the second main switching element Qy.

Furthermore, the forward type DC-DC converter of active clamp system according to the present embodiment is suitable for a DC-DC converter having a small step-down rate. In a DC-DC converter having a large step-down rate (for example, a converter that steps down the input voltage to 1/20 or less), a capacitance component on the secondary side seen from the primary side via the transformer T1 is very small. On the other hand, in a DC-DC converter having a small step-down rate (for example, a converter that steps down the input voltage to 1/2 or 1/4), a capacitance component on the secondary side seen from the primary side via the transformer T1 becomes large. Therefore, a resonance frequency of a surge voltage caused by resonance generated by the resonance inductor on the primary side and the capacitance component on the secondary side becomes low. Therefore, it becomes more important to suppress the surge voltage.

Heretofore, the embodiment 2 of the present invention has been described. The embodiment 2 is an example. It will be appreciated by those skilled in the art that various modifications are possible in combinations of components and processing processes and such modifications are also within the scope of the present embodiment.

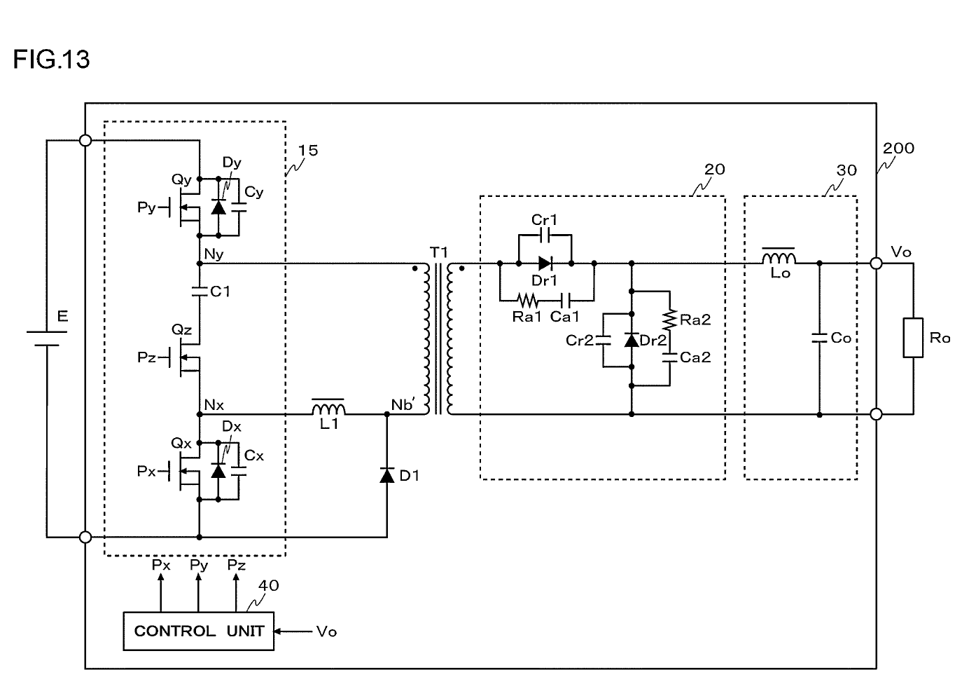

FIG. 13 is a diagram illustrating a configuration example of a two-transistor forward type DC-DC converter 200 according to a modification of the embodiment 2. In the modification, the resonance inductor L1 is connected between the node Nx and the lower terminal of the primary winding of the transformer T1. The protective diode D1 is connected between a node Nb′ between the resonance inductor L1 and the lower terminal of the primary winding of the transformer T1, and the power line on the low voltage side of the DC power supply E. Specifically, a cathode terminal of the protective diode D1 is connected to the node Nb′ and an anode terminal is connected to the power line. The DC-DC converter 200 according to this modification also behaves in the same way as the DC-DC converter 200 illustrated in FIG. 11.

Furthermore, an example in which the rectifier circuit 20 includes the first rectifier diode Dr1 and the second rectifier diode Dr2 has been described in the embodiment 2. Instead of them, however, switching elements such as MOSFETs may be used. In this case as well, resonance is caused between parasitic capacitance of the switching element and the resonance inductor on the primary side. However, the influence of the resonance can be reduced by the protective diode D1.

Furthermore, an example in which a parasitic capacitance and a parasitic diode are formed in parallel with a switching element has been described. However, a capacitance element (for example, a snubber capacitor) and/or a diode element may be connected in parallel with the switching element.

Furthermore, instead of the DC power supply E which supplies the input voltage to the two-transistor forward type switching circuit 15, an AC power supply, a rectifier circuit, and a Power Factor Correction (PFC) circuit may be used.

What is claimed is:

1. A full bridge type switching power supply apparatus comprising:
a full bridge circuit having a parallel connection of a first arm including two switching elements and a second arm including two switching elements;
a transformer which transforms output power of the full bridge circuit;
a first inductor connected between an output terminal of the first arm and one terminal of a primary winding of the transformer;
a second inductor connected between an output terminal of the second arm and the other terminal of the primary winding of the transformer;
a rectifier circuit connected to a secondary winding of the transformer to rectify output power of the transformer;
a smoothing circuit which smoothes power rectified by the rectifier circuit;
a first diode of which an anode terminal is connected to a first node between the first inductor and the one terminal of the primary winding, and of which a cathode terminal is connected to a power line on a high voltage side of a power supply which supplies power to the full bridge circuit;
a second diode of which a cathode terminal is connected to the first node and of which an anode terminal is connected to a power line on a low voltage side of the power supply;
a third diode of which an anode terminal is connected to a second node between the second inductor and the other terminal of the primary winding, and of which a cathode terminal is connected to the power line on the high voltage side of the power supply; and
a fourth diode of which a cathode terminal is connected to the second node and of which an anode terminal is connected to the power line on the low voltage side of the power supply.

2. The full bridge type switching power supply apparatus according to claim 1, further comprising a control unit which controls the full bridge circuit, wherein
after a parasitic capacitance of each of the switching elements is discharged by a current based upon the first inductor and the second inductor, the control unit turns ON the switching element.

3. A full bridge type switching power supply apparatus comprising:
a full bridge circuit having a parallel connection of a first arm including two switching elements and a second arm including two switching elements;
a transformer which transforms output power of the full bridge circuit;
an inductor connected between an output terminal of the first arm and one terminal of a primary winding of the transformer;
a rectifier circuit connected to a secondary winding of the transformer to rectify output power of the transformer;
a smoothing circuit which smoothes power rectified by the rectifier circuit;
a first diode of which an anode terminal is connected to a first node between the inductor and the one terminal of the primary winding, and of which a cathode terminal is connected to a power line on a high voltage side of a power supply which supplies power to the full bridge circuit; and
a second diode of which a cathode terminal is connected to the first node and of which an anode terminal is connected to a power line on a low voltage side of the power supply.

4. The full bridge type switching power supply apparatus according to claim 3, further comprising a control unit which controls the full bridge circuit, wherein
after a parasitic capacitance of each of the switching elements is discharged by a current based upon the inductor, the control unit turns ON the switching element.

5. The full bridge type switching power supply apparatus according to claim 1, wherein
the switching elements are Metal Oxide Semiconductor Field Effect Transistors (MOSFETs).

6. A two-transistor forward type switching power supply apparatus comprising:
a two-transistor forward type switching circuit of active lamp system;
a transformer which transforms output power of the two-transistor forward type switching circuit;
an inductor connected between the two-transistor forward type switching circuit and a primary winding of the transformer;
a rectifier circuit connected to a secondary winding of the transformer to rectify output power of the transformer;
a smoothing circuit which smoothes power rectified by the rectifier circuit; and
a diode of which an anode terminal is connected to a first node between the inductor and the primary winding of the transformer, and of which a cathode terminal is connected to a power line of a power supply which supplies power to the two-transistor forward type switching circuit.

7. The two-transistor forward type switching power supply apparatus according to claim 6, wherein
the two-transistor forward type switching circuit includes:
a first main switching element connected between a power line on a low voltage side of the power supply and a second node to which a path to one terminal of the primary winding of the transformer is connected;
a second main switching element connected between a power line on a high voltage side of the power supply and a third node to which a path to the other terminal of the primary winding of the transformer is connected; and
an auxiliary switching element and a capacitance connected in series between the second node and the third node,
the inductor is connected between the third node and the other terminal of the primary winding of the transformer or between the second node and the one terminal of the primary winding of the transformer, and
the diode is connected between the first node and the power line on the high voltage side of the power supply.

8. The two-transistor forward type switching power supply apparatus according to claim 7, further comprising a control unit which controls the two-transistor forward type switching circuit, wherein
after parasitic capacitances of the first main switching element and the second main switching element are discharged by a current based upon the inductor, the control unit turns ON the first main switching element and the secondmain switching element.

9. The two-transistor forward type switching power supply apparatus according to claim 7, wherein
the first main switching element and the second main switching element are Metal Oxide Semiconductor Field Effect Transistors (MOSFETs).
